(19) United States
(12) Patent Application Publication
(10) Pub. No.: US 2019/0272460 A1
(43) Pub. Date: Sep. 5, 2019

(54) CONFIGURABLE NEURAL NETWORK PROCESSOR FOR MACHINE LEARNING WORKLOADS

(71) Applicant: Ye TAO, SHREWSBURY, MA (US)

(72) Inventor: Ye TAO, SHREWSBURY, MA (US)

(21) Appl. No.: 15/912,544

(22) Filed: Mar. 5, 2018

(51) Int. Cl. G06N 3/04

(52) U.S. Cl. CPC G06N 3/0454

(57) ABSTRACT

A configurable neural network processor is provided for accelerating machine learning workloads via increased hardware parallelism and optimized memory efficiency. A command interface receives commands from host processor, a packet generator transforms commands into packets, a packet dispatcher intelligently issues packets to processing units, a memory interface interfaces with local or host memory, and a communication media enables data transfer among various modules.

### FIELD OF THE INVENTION

One or more aspects of the invention generally relate to machine learning, and more particularly in accelerating neural network workload via increased hardware parallelism and optimized memory efficiency.

### BACKGROUND

Due to the nature of multi-layer topology, non-linear computational model and huge batch dataset, neural network applications have become one of the most data intensive and compute intensive workloads which require both a vast number of computation units and large amounts of memory system. Current neural network applications are mostly run on general processing units (“GPUs”) because of its superior thread parallelism. However, GPUs are initially designed with the goal of maximizing graphic processing capability. Even though they are widely used in processing neural network workloads, i they are not naturally designed for such work. Units dedicated to graphic processing will be left unused in running machine learning workloads, which leads to inferior energy efficiency.

Having realized that, many companies started to build their own processors specifically for neural network workloads, aiming to achieve higher energy efficiency as well as better performance. For example, Google deployed self-designed tensor processing unit (“TPU”) into its cloud data center for accelerating machine learning applications and Apple designed its own neural engine in its latest iPhone for superior energy efficiency and performance.

Accordingly, it would be preferable to have a customized design rather than use a general-purpose processor for processing neural network workloads to enhance run time performance as well as energy efficiency.

### SUMMARY OF THE INVENTION

Embodiments of the present invention provide a computing system, comprising a host computer and a neural network processor. The host computer comprises a host memory, a host processor operable to generate commands in response to execution of an application stored in the host memory, and a system interface operable to output the commands generated by the host processor. The neural network processor comprises a command interface operable to receive the commands from the system interface of the host computer, the commands including information about a multi-layer neural network, a packet generator operable to transform arbitrated commands received from the command interface into packets, each packet including information about an individual neuron in the network, a plurality of processing units operable to implement operations performed by neurons in the network, a packet dispatcher operable to issue the packets received from the packet generator to the processing units, and a connection table associated with each processing unit through which the plurality of processing units in a first layer communicate with each other and with processing units in adjacent second layers, whereby the plurality of processing units in the first and second layers dynamically chain together to form a configurable topology resulting in a direct mapping of the neuron network.

### BRIEF DESCRIPTION OF THE DRAWINGS

Accompanying drawings show exemplary embodiments in accordance with one or most aspects of the present invention. Notably, the accompanying drawings should only be treated as way of description, and should not be used to limit the present invention to the embodiments shown. As used herein, references to one or more embodiments are for illustrative purpose only to better describe a particular feature, structure, or characteristic included in at least one implementation of the invention. And phrases such as “in one embodiment” or “in an alternate embodiment” appearing herein describe various realization of the invention, and do not necessarily all refer to the same embodiment.

FIG. 1 is a block diagram of one embodiment of a computing system including a host computer and an attached neural network processor.

FIG. 2 is a block diagram of an embodiment of the neural network processor pipeline of FIG. 1.

FIG. 3 is a flow diagram of an exemplary embodiment of transformation logic of FIG. 2 in accordance with one or more aspects of the present invention.

FIG. 4 is a block diagram of an alternate embodiment of the neural network processor pipeline of FIG. 1.

FIG. 5A is an illustration of a logical view of the scoreboard unit of FIG. 2 in accordance with some embodiments.

FIG. 5B is an embodiment of a logical view of a connection table inside the processing unit of FIG. 2 and FIG. 4.

FIG. 6 is block diagram of an embodiment of the processing unit pipeline of FIG. 2 in accordance with some embodiments.

FIG. 7 is a block diagram of an embodiment of one type of processing unit pipeline of FIG. 4 in accordance with some embodiments.

FIG. 8 is a block diagrams of an embodiment of another type of processing unit pipeline of FIG. 4 in accordance with some embodiments.

### DETAILED DESCRIPTION

Embodiments of the disclosure describe methods, diagrams and systems for a configurable neural network processor. Several terms of the art are used throughout the description, which are to take on their ordinary meaning in the art, unless specifically defined herein. Numerous details are provided for a better understanding of present invention but which should not be treated as any form of limitations. Features that are obvious to one of skill in the art may be omitted from detailed description in order to avoid obscuring the present invention.

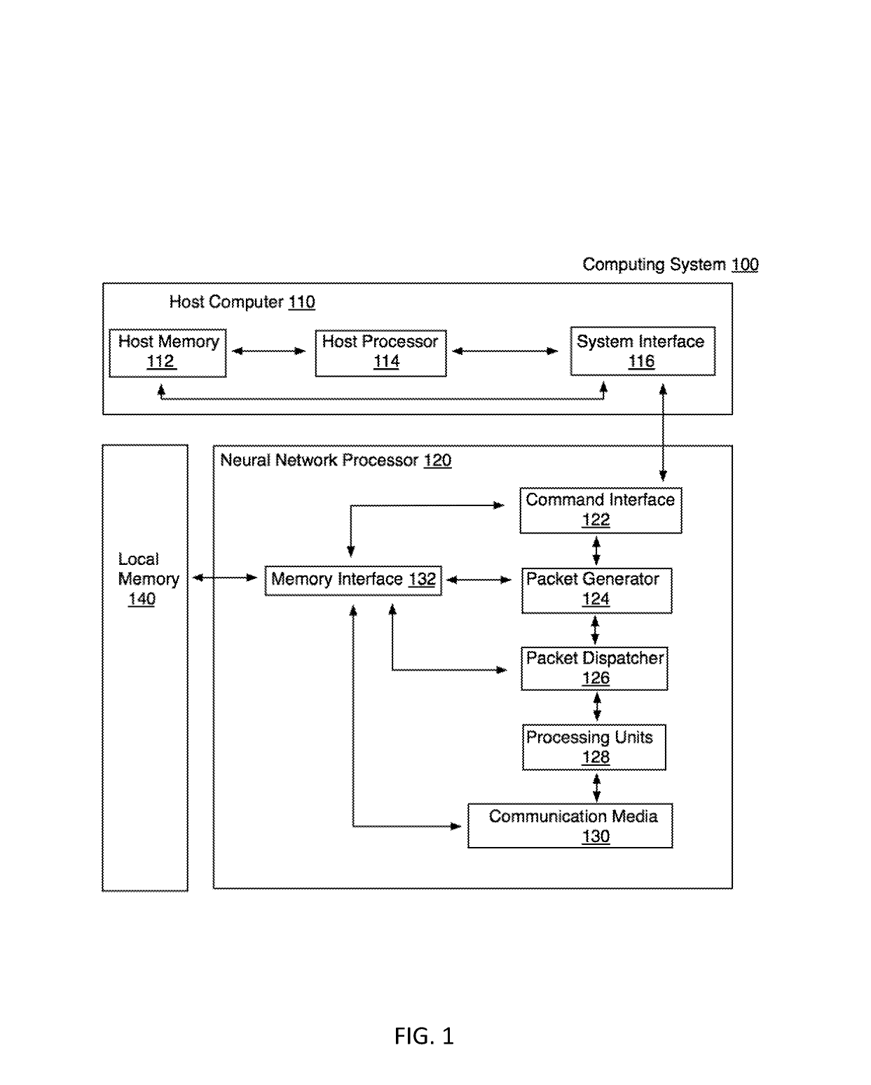

FIG. 1 is an illustration of a computing system commonly used with a neural network processor attached in accordance with some embodiments. In the embodiment shown in FIG. 1, a computing system 100 includes a host computer 110 and a neural network processor 120 attached to it. Computing system 100 may be a portable device, cellphone, game console, tablet computer, laptop computer, desktop computer, sever, workstation, domain specific embedded system, computer based simulator, or the like. Host computer 110 may have various forms, all sharing the common building blocks including host processor 114, host memory 112 and system interface 116. Host processor 114 is able to communicate with host memory 112 using a memory controller (not shown here) or system interface 116. System interface 116 may be an input/output interface or a bridge device including a memory controller to interface directly to host memory 112. Typical input/output interfaces are PCIe, SCSI, AMBA, USB, SPI, I2C or the like and commonly used bridge devices includes Intel Northbridge and Intel Southbridge.

Commands can be issued from machine learning applications running on host computer 110, which may include convolution operations, various forms of pooling, normalization, linear and non-linear activation operations with any forms of data inputs stored in host memory 112. These commands get sent to neural network processor 120 through system interface 116, which will be received and stored in command interface 122. Command interface 122 may also implement a logic to generate interrupts, exceptions or events for notifying host processor 114 after processing has finished, or it may keep a local state that host processor 114 can pool from. Final results can be stored in host memory 112, local memory 140 or command interface by reusing entries of the original commands.

Commands received in command interface 122 will get arbitrated and sent to packet generator 124, where they will be transformed into packets and then forwarded to packet dispatcher 126. In one embodiment, the commands received from host computer 110 carry the information of entire network, including but not limited to input data, topology of neuron network, total number of layers, number of neurons in each layer, specific types and operations performed by each neuron etc. This information is too broad and high level for lightweight processing units 128 to interpret. So, one job of packet generator 124 is to translate this broad and high-level information into packets which contain data and operations specific to each neuron. More specifically, this transformation procedure includes one or more stages of extracting input data from commands, identifying local information associated with each neuron, such as connection of adjacent layer, weights, activation function, operation performed or the like, optionally fetching any needed data through memory interface 132, and assembling them into one or more packets. In another embodiment, commands received from host computer 110 may be results of driver transformation and only carry low level local information that can be directly interpreted by processing units 128. In this case, packet generator 124 is not required and packet dispatcher 126 will be responsible for fetching any needed data via memory interface 132, before forwarding packets to processing units 128.

Packet dispatcher 126, after receiving packets generated by packet generator 124, issues packets to processing units 128 for packet processing. Packet dispatcher 126 can be viewed as the central controller of processing units 128, with the capabilities of job dispatching, frequency management, voltage management etc. For example, packet dispatcher 126 can wake up a portion of processing units 128, sending packets to them for processing, adjusting frequency and voltage of active processing units for better performance or energy efficiency, and sleep any processing units after packet processing completes.

Processing units 128 constitute at least one type of processing unit, which contains one or more processing units. In one embodiment, there is only one type of processing unit. Each processing unit implements all operations performed by a single neuron including but not limited to addition, multiplication, linear and non-linear activation functions, various pooling functions etc. In another embodiment, there are more than one type of processing unit in 128. Each type of processing unit implements partial functionalities of a single neuron. By collaborating with each other, complete tasks done in a single neuron can be computed. Processing units 128 can communicate with memory interface 132 for transferring data, intermediate and final results via communication media 130. Data generated or absorbed by processing units 128 may be stored in host memory 112, local memory 140, or local cache inside memory interface 132.

Communication media 130 is responsible for data transfer between various blocks in neural network processor 120. In one embodiment, it may use a form of an on-chip network to provide high bandwidth connection among processing units 128 and memory interface 132. In an alternative embodiment, it can use a form of central bus to offer low latency communication among all blocks connected to it.

Memory interface 132 is the gateway between core processing logic and memory. It can send operations to or receive operations from local memory 140, host memory 112 for data transfer and also accept commands from other blocks of core processing logic. Inside the memory interface 132, local cache and scratchpad memory may be implemented to further optimize data locality and access latency.

Local memory 140 is a piece of memory that resides near neural network processor 120. As the system interface 116 is likely to be shared with multiple agents, having a locally attached memory has the advantages of shorter data access latency, higher bandwidth and more flexible data management. Local memory 140 can include any forms of volatile and non-volatile memory, such as DRAM, HBM, DDR memory, SSD, or the like.

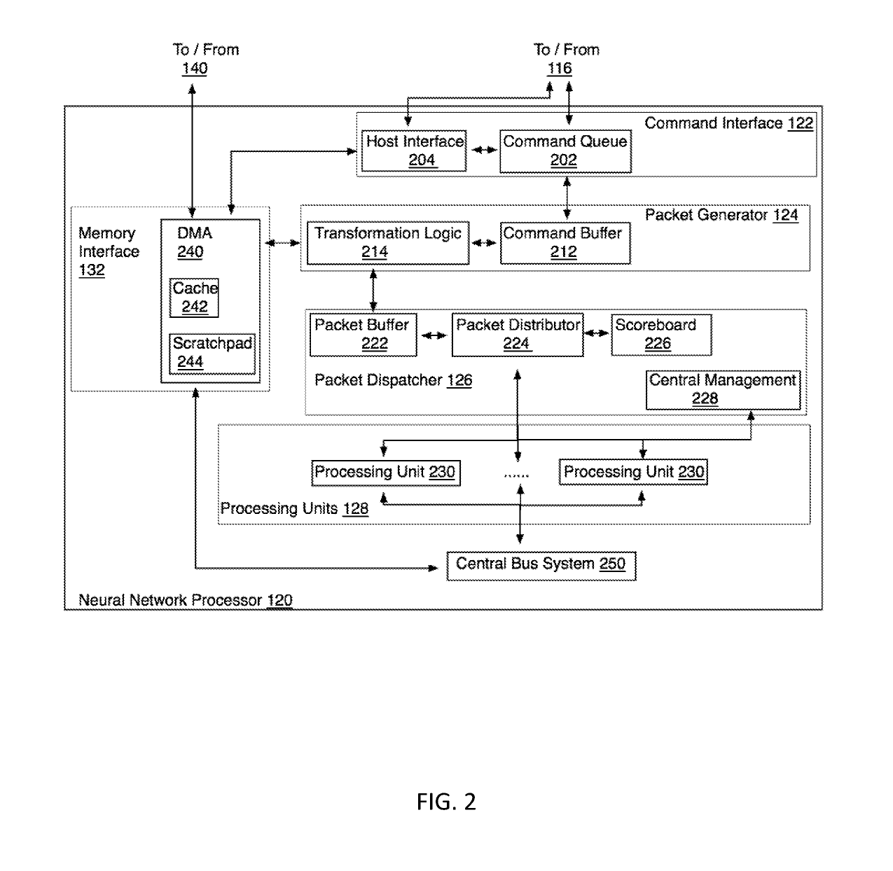

FIG. 2 is a block-level illustration of an embodiment of neural network processor 120 shown in FIG. 1. Command interface 122 includes a command queue 202 and a host interface logic 204. As commands are received from system interface 116, they are stored in command queue 202. After commands are sent out of command queue 202, original command queue space may be reserved for state variable used to track processing status and optionally for storing final results. Host interface logic 204 provides capabilities to signal back to host processor 114 after processing has completed. It may implement functionalities like interrupt signaling, event generation or processing state keeping for the host processor 114 to pull from. Host interface logic 204 also has the logic to communicate with memory interface 132 for data transfer.

Valid commands, after being stored in command queue 202, will be sent to packet generator 124. In one embodiment, packet generator 124 contains a command buffer 212 for temporary command storage and transformation logic 214 to extract information local for each neuron and assembling them into packets. After commands are received and stored in command buffer 212, transformation logic 214 starts packet generation process by: 1) Identifying number of layers in the network, number of neurons in each layer, adjacent layer connections of each neuron. 2) Interfacing with memory interface 132 for fetching any needed data including inputs and weights using the address specified in commands. 3) Specifying activation function used in each layer and instructing processing units 128 to select pre-implemented activation functions and optionally load associated lookup table if selected activation functions are not pre-implemented. After packets are generated, they will get forwarded downstream for packet dispatching.

Packets sent from transformation logic 214 are then queued into work buffer 222 which will be dispatched by work distributor 224 based on the availability of processing units. An internal scoreboard 226 is implemented inside packet dispatcher 126 for keeping track of availability of processing units 128 as well as the mapping between neurons and processing units. After packets are received at work buffer 222, work distributor 224 becomes active. Based on the availability of processing units 128 tracked by scoreboard 226, work distributor may either forward packets into available processing units, or signal back to work buffer that no resource is available so that packets need to be queued longer. Work distributor 224 also updates scoreboard 226 each time a packet is sent to a processing unit or is fully processed by processing unit. Central management logic 228 is responsible for power management of all processing units including dynamically adjusting clock frequency and voltage of processing units for better performance and energy efficiency, power down processing units that are idle, and waking up processing units when new packets come.

Processing units 128 constitute a pool of processing units 230 which can be allocated and freed dynamically by packet distributor 224. In one embodiment shown here, processing units 128 contain only one type of processing unit 230, with the ability to compute linear arithmetic functions, such as multiplication and addition, as well as complex non-linear activation functions, such as various forms of activation functions. Each processing unit 230 receives and processes packets associated with a single neuron in the network. By having multiple processing units 230 in parallel, layers of neurons can be processed at same time which greatly improves performance.

In addition, a connection table is implemented in processing unit 230 to track its previous layer input neurons and next layer output neurons. Processing units 230 are able to communicate with each other through communication media 130 using connection information stored in connection table. Using this mechanism, processing units can be dynamically chained together to form a configurable topology which allows direct mapping of any neuron networks. By chaining processing units to reflect the topology of neuron network under processing, intermediate results can be directly passed between layers without involving local memory, which significantly reduces the number of redundant memory accesses for communicating intermediate results and leads to better performance as well as energy efficiency.

A central bus system 250, is used as the communication media in this embodiment to provide low latency, fast communication among processing units and memory interface. Other forms of communication media also exist and may be used, such as switch, on-chip network with various topology and routing algorithms. However, those are beyond the scope of illustration of the present invention thus will not be explained in detail.

Memory interface 132 constitutes of a direct memory access logic 240 for data accessing, which may further include a local cache 242 to exploit data locality as well as access latency, and a scratchpad memory 244 for the ease of data management.

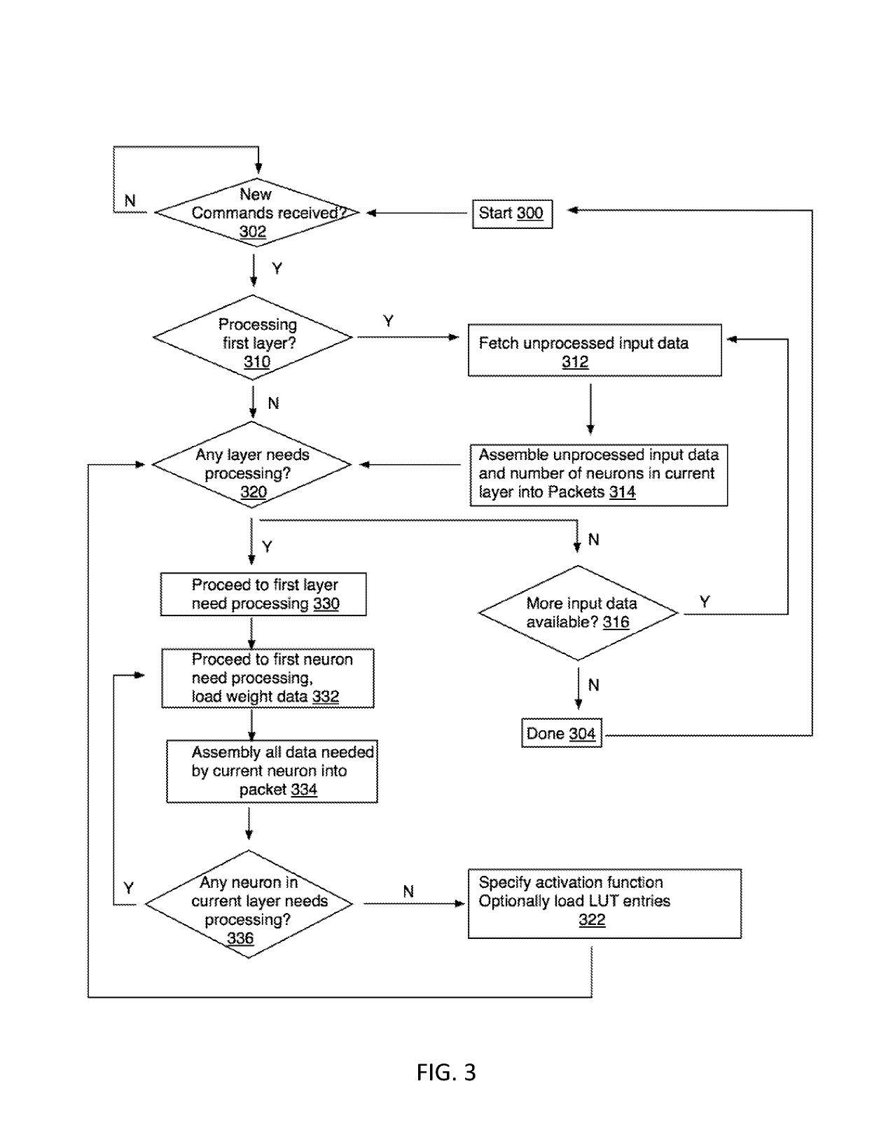

FIG. 3 shows a flow diagram of an embodiment of a packet generation algorithm in accordance with one or more aspects of the present invention. Although being described here as an implementation of transformation logic 214, the same algorithm can be implemented in different places, in hardware or in software. In addition, the steps may be reordered. Thus, the description below should be treated as for illustrative purpose only. Also, while the algorithm is described step by step, in an actual implementation, some steps can overlap with others, some steps may be skipped conditionally, and similar process flows are possible.

Step 300 is the start of the algorithm. Commands generated by applications such as machine learning workloads running on host processor 114 normally use a compact format including information of the entire network as a whole, which requires transformation before processing units can work. After valid commands are received in step 302 from upstream by transformation logic 214, the packet generation process starts. The first step performed in step 310 is a check on whether current layer under processing is the first layer. Since only the first layer of the neural network receives input data, all following layers will use the intermediate results passed from previous layers. If the current layer is the first layer, transformation logic will start data loading via memory interface 132 and assembling into packets input data and the number of neurons in current layer, which corresponds to step 312 and step 314, respectively. Following step 314, step 320 will perform a check to determine whether all layers have been processed. If not, the transformation logic will proceed to the first unprocessed layer in step 330. In step 332, weight data of the first unprocessed neuron will be loaded from host memory 112 or local memory 140 through memory interface 132. Then, it will be forwarded directly to processing units 128 without caching through packets generated in step 334. In the next step 336, a check will be performed to see whether there any unprocessed neurons are left in the current layer. If there so, the transformation logic will loop back to step 332 for processing the next unprocessed neuron, loading weights, and creating packets. These steps will be repeated until all neurons in the current layer have been processed.

After all of the neurons in the current layer have been processed, the transformation logic will proceed to step 322, specifying the activation function to be used in the current layer and optionally load lookup table entries if the activation function used is not implemented in the processing units. Following a complete processing of the current layer, step 320 is performed again to determine whether there are any unprocessed layers left. If there are, the transformation logic will enter step 330 to process the next unprocessed layer. This procedure repeats until all layers in the network have been processed. Then, in step 316, there will be a check to determine whether all input data have been sent downstream. The reason for this check is that not all input data are sent out at once in step 314. This is mainly for performance reasons as waiting for all input data being loaded from memory may take a long time. Having this check in a later stage allows packet processing to start as soon as some inputs are ready and remaining inputs can be sent later. Thus, if there is more input data for processing, unprocessed input data will be fetched from cache or memory in step 312 and sent downstream in step 314. And, in the following step 320, transformation logic will detect whether all layers have been processed and directly jump to step 316 for another check to determine whether there is any input data left. This process continues until all input data are sent out after which the transformation logic will enter a Done state 304 and wait for new commands to arrive.

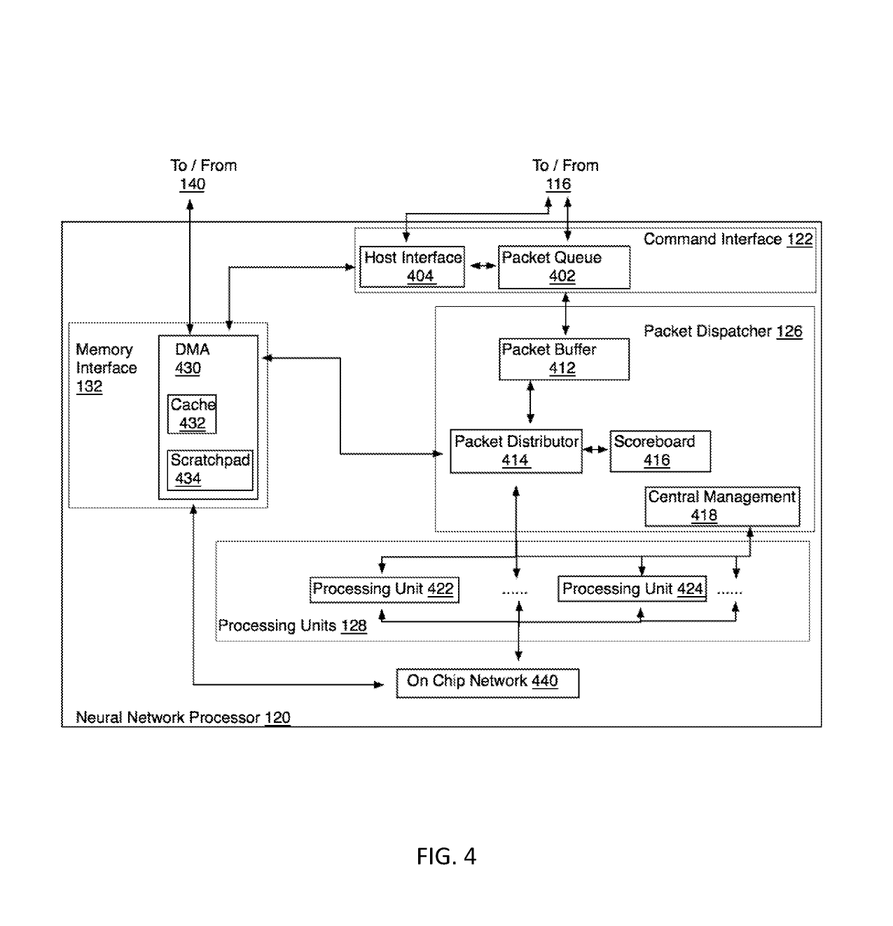

FIG. 4 is a block diagram of an alternate embodiment of the neural network processor pipeline of FIG. 1. Most of blocks are the same as those in FIG. 2. Notably, in the embodiment of FIG. 4, commands received from host processor 114 have been pre-translated by host software using the algorithm shown in FIG. 3. Host software here may be a specialized compiler, driver, libraries, or the like. Thus, a packet generation stage is not required. Work distributor 414 will be responsible for fetching input and weight data via memory interface 132 before issuing packets to processing units 128.

In this embodiment, processing units 128 constitute two types of processing units 422 and 424, with at least one processing unit of each type. More than two types of processing units may also be used, each implementing a different set of functions performed by a neuron but which together implement the complete functions performed by the neuron. For an example described in this embodiment, all linear arithmetic functions are implemented in processing unit 422 and all non-linear operations will be handled by processing unit 424. Packets received from the work distributor will be first sent to processing unit 422 for linear arithmetic processing, such as multiplication and accumulation; then the results of processing unit 422 will be forwarded to processing unit 424 for non-linear activation operations. The advantages of this scheme are ease of pipelining as well as more balanced resource utilization. As an example, the processing of multiplication and accumulation takes much longer than non-linear activation operation for neurons with many inputs (which is a common case in most of neural networks). Thus, a design may implement more processing units 422 and fewer processing units 424 in order to keep both of them busy most of time, which leads to a more balanced and efficient resource utilization. Processing unit 422 and 424 communicate with each other, local memory 200, host memory 112 via memory interface 132, through communication media 130, which is implemented as on-chip network 440 in this embodiment.

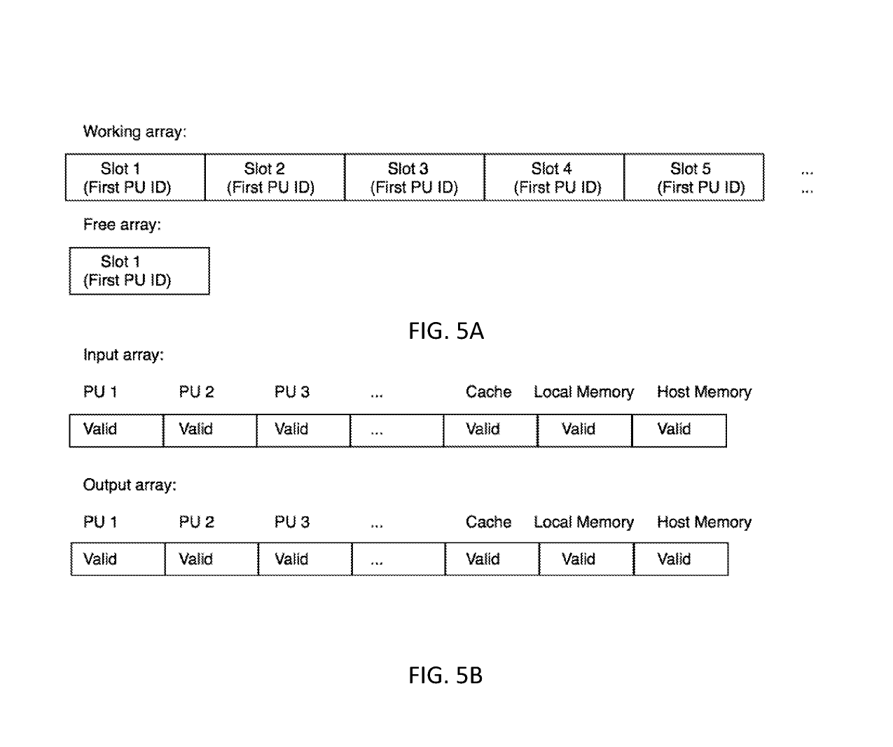

FIG. 5A is an exemplary embodiment of a logical view of scoreboard 226 in packet dispatcher 124. Scoreboard 226 maintains two types of arrays locally. One array is used to track a mapping between active processing units and layers under processing. Each slot corresponds to a layer currently being working on. For example, Slot 1 is used to track active processing units dedicated to process the first layer of the neural network, Slot 2 keeps track of active processing units working on the second layer, etc. Each slot stores the ID of the first processing unit. A processing unit ID always starts from one, and a zero means that no processing unit is active. As another example, for a simple neuron network consisting of 3 layers, with 10 neurons in the first layer, 15 neurons in the second layer and 10 neurons in the third layer. There will be 10+15+10=35 active processing units in total with each processing unit dedicated to one neuron. The first layer will be mapped to processing units 1 to 10, the second layer will be processed by processing units 11 to 25 and the third layer will be allocated to processing units 26 to 35. Slot 1 in working array will store the ID of the first processing unit for layer 1, which is 1. Slot 2 will have a value of 11, and Slot 3 will have a value of 26. All remaining slots in the working array have a value of 0. There is another array implemented to track the number of free processing units in parallel. Similarly, it will store the ID of first inactive processing units and only one slot is needed in this case. Using the same example above, the only slot in the free array will store a value of 36. When the processing of any layer is finished, the corresponding slot in the working array will be reset to 0. Any number of available processing units can be computed based on the processing unit ID stored in the working array and the free array.

FIG. 5B is an exemplary embodiment of a logical view of connection table inside a processing unit. Similar to FIG. 5A, it implements two types of arrays locally, which are used to track processing units corresponding to neurons of adjacent layers. Each array is a bitstream with bit-width equals to the total number of processing units plus all forms of memory, such as cache, local memory, host memory etc. The position of each bit corresponds to the ID of a specific processing unit or one type of memory. A bit value of 1 in the input array means that a valid input is received from the processing unit pointed to by this bit. Similarly, a bit value of 1 in the output array means that final results of the specified neuron will be forwarded to a processing unit pointed to by this bit. As an example, assuming there are 7 processing units and 1 memory in a neural network processor. A connection table in processing unit 4 with an input array equaling to 1010_0000 and an output array equaling to 0000_1100 means this processing unit receives input from processing units 1, 3 and will send outputs to processing units 5, 6. Using this information, processing units can be dynamically chained together to form a neural network of any topology and intermediate results can be easily streamed back and forth when the application is doing inferencing or training.

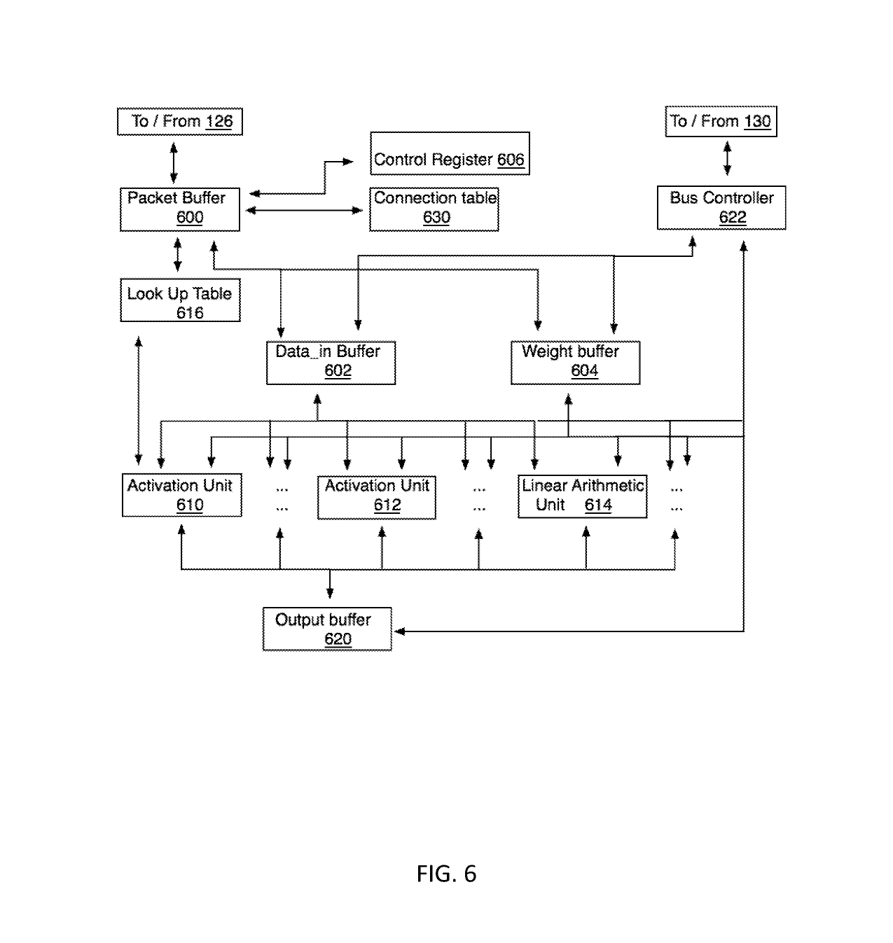

FIG. 6 is a block diagram of an embodiment of the processing unit 230 of FIG. 2. This processing unit implements all functions performed by a single neuron. Packets sent from packet dispatcher 126 are first stored in packet buffer 600; then they will be forwarded to appropriate block based on packet type. In one embodiment, three packet types are implemented: data packet, weight packet and control packet. A data packet carries data input in its payload which will then be forwarded to data_in buffer 602. A weight packet includes weight related information in payload and will be stored in weight buffer 604. A control packet can have multiple roles. For example, a control packet may be used for adjusting frequency and voltage of a processing unit via updating control register 606, specifying adjacent layer connection information via programming connection table 630 or specializing activation function by setting lookup table 616. Packet processing starts after data_in buffer 602, weight buffer 604 and activation function are selected. As an example, inputs in data_in buffer 602 and weights in weight buffer 604 will take a first pass through linear arithmetic units 614 for computing the sum of the total product with partial results stored in output buffer 620. Then, the partial results in output buffer 620 will take another pass through lookup table based activation unit 610 or custom-designed activation unit 612 for non-linear activation operation. After that, depending on the operation performed in the next layer, output may be sent to linear arithmetic unit 614 for pooling operation if the next layer does POOLING. Or it may be sent to bus controller 622 and be forwarded to other processing units, local or host memory based on adjacent layer connection information programmed in connection table 630.

Data from other processing units, local or host memory may be received by bus controller 622 as well, which can be forwarded to data_in buffer 602 or weight buffer 604 depending on data types. After all data processing completes, the processing unit will signal back to packet dispatcher 126 that new data can be accepted. In case there is no more data to be sent, packet dispatcher 126 may place this processing unit into a sleep mode for energy efficiency.

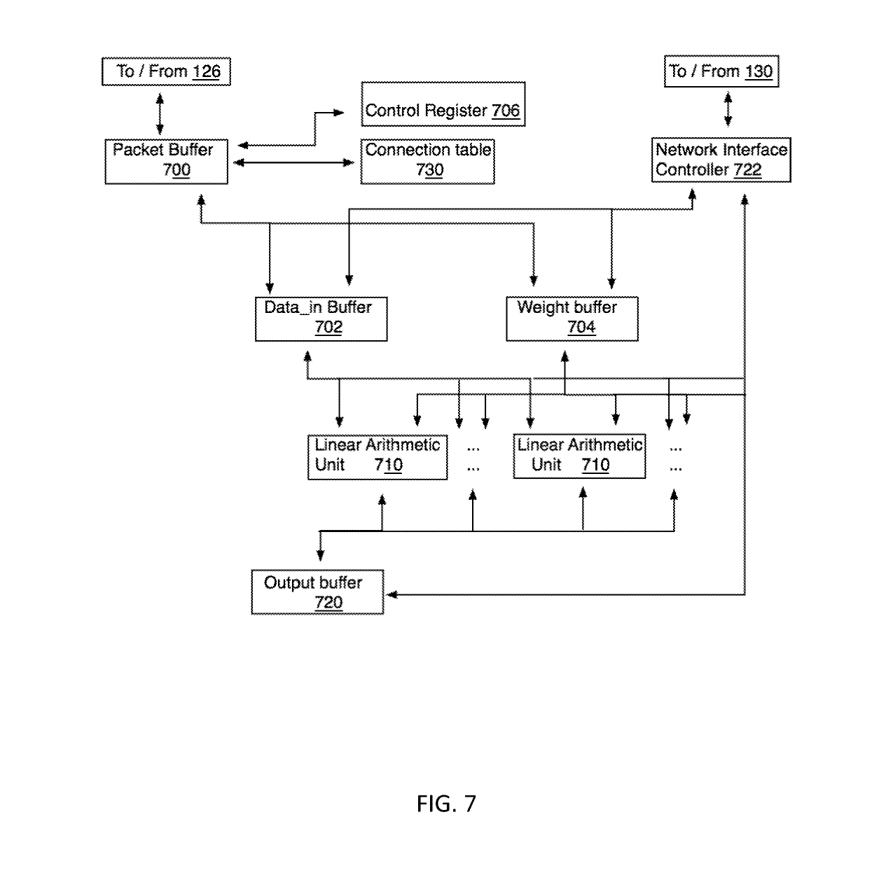

FIG. 7 is a block diagram of an embodiment of the processing unit 422 of FIG. 4. This processing unit 422 implements all linear arithmetic operations performed by a single neuron, including addition, multiplication, various pooling functions, etc. However, non-linear operations used in activation function will not be included. Thus, collaborating with processing unit 424 is required for completing all computations performed by a single neuron. Packets sent from packet dispatcher 126 are first stored in packet buffer 700, then they will get forwarded to appropriate blocks downstream based on packet type. Similar to processing unit 230 described above, the packet type may be data packet, weight packet, or control packet. A data packet aims to provide data inputs and may include additional information of input data such as input dimensions etc. Input data will be forwarded to data_in buffer 702. A weight packet contains the weight information used in data processing, which will be stored in weight buffer 704. A control packet is used to pass control related information such as adjusting operating state of processing unit, logging adjacent connection data, which will update control register 706 and connection table 730 respectively. If data_in buffer 702 and weight buffer 704 are both valid, computation can start with first passing input data and associated weights to linear arithmetic units for computing sum of total products of inputs and weights. Corresponding results will be stored in output buffer 720 and forwarded to processing unit 424 for activation operations via network interface controller 722. After processing is finished, the result will be received by network interface controller 722 from processing unit 424 via on-chip network 440, and will then be sent to linear arithmetic unit 710 for pooling or other processing units based on adjacent connection information stored in connection table 730. Network interface controller 730 may also pass any new data received from on-chip network 130 to data_in buffer 702 or weight buffer 704, depending on the data types.

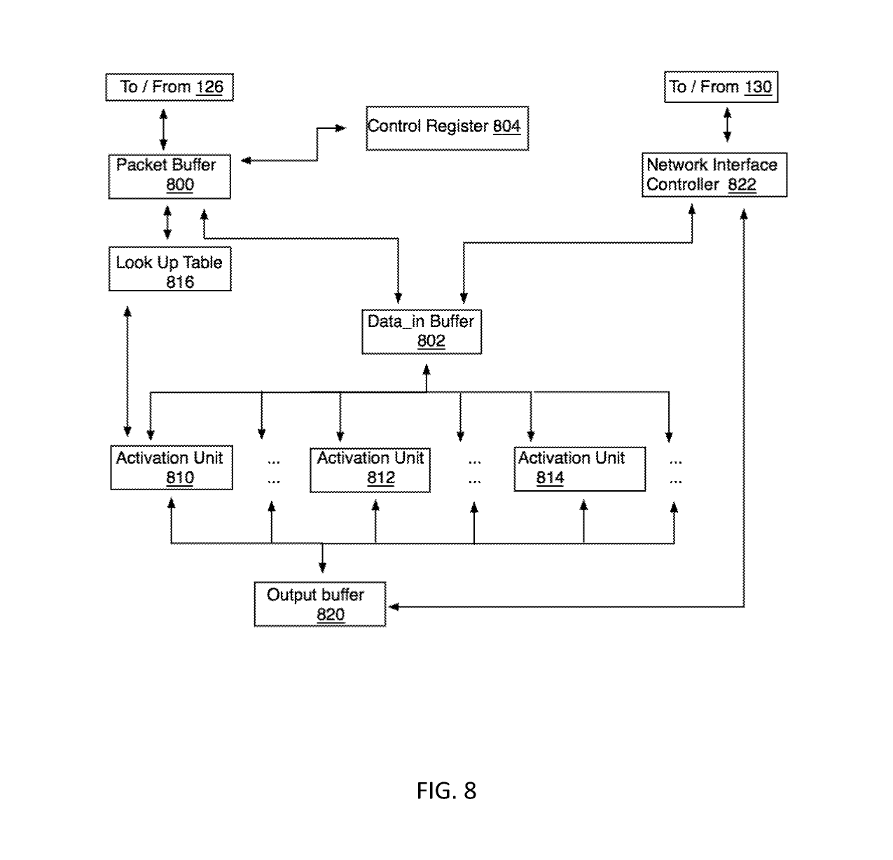

FIG. 8 is a block diagram of an embodiment of the processing unit 424 of FIG. 4. This processing unit 424 is primarily responsible for complex activation function processing which is complementary to processing unit 422. Packets received from packet dispatcher 126 may be control packets which provides lookup table data associated with activation function to program look-up table 816, or frequency and voltage management packets used to configure control register 804. Input data coming from processing unit 422 via on-chip network 440 will be directed by network interface controller 822 to data_in buffer 802. Then, those data will be forwarded to a lookup table (LUT) based or custom-designed activation unit for activation function computation with final result stored in output buffer 820. Those results will be sent back to originated processing unit 422 via network interface controller 822. Data in buffer 802 is able to buffer inputs from multiple processing units 422. All of them can be processed in parallel via multiple activation units for higher utilization rate and better performance.

While foregoing is directed to embodiments in accordance with one or more aspects of the present invention, notably, various modification and enhancement can be made thereto without departing from the broader scope of the present invention, which is determined by the claims that follow. Claims listing steps do not imply any order of the steps unless such order is explicitly indicated.

What is claimed is:

1. A computing system, comprising:
a host computer, comprising:
a host memory;
a host processor operable to generate commands in response to execution of an application stored in the host memory; and
a system interface operable to output the commands generated by the host processor; and
a neural network processor, comprising:
a command interface operable to receive the commands from the system interface of the host computer, the commands including information about a multi-layer neural network;
a packet generator operable to transform arbitrated commands received from the command interface into packets, each packet including information about an individual neuron in the network;
a plurality of processing units operable to implement operations performed by neurons in the network;
a packet dispatcher operable to issue the packets received from the packet generator to the processing units; and
a connection table associated with each processing unit through which the plurality of processing units communicate with each other and with local or host memory, whereby the plurality of processing units dynamically chain together to form a configurable topology resulting in a direct mapping of the neuron network.

2. The computing system of claim 1, wherein the packet generator is configured to transform arbitrated commands into packets by:
extracting input data from the commands;
identifying local information associated with each neuron; and
assembling the data into one or more packets.

3. The computing system of claim 1, wherein the packet dispatcher is further operable to improve performance and energy efficiency of the processing units.

4. The computing system of claim 1, wherein the packet dispatcher is further operable to improve performance and energy efficiency of the processing units by managing clock frequency and voltage of the processing units.

5. The computing system of claim 1, wherein the packet dispatcher is further configured to improve performance and energy efficiency of the processing units by:
powering up one or more processing units in advance of issuing packets; and
powering down the one or more processing units following completion of packet processing.

6. The computing system of claim 1, wherein each of the plurality of processing units is operable to implement all of the operations performed by a single neuron.

7. The computing system of claim 1, wherein each of several of the plurality of processing units is operable to implement fewer than all of the operations performed by a single neuron, whereby all of the operations performed by the single neuron are implemented collectively in parallel by the several processing units.

8. The computing system of claim 1, wherein the plurality of processing units is further operable to intermediate pass results between network layers via the connection table without first storing the intermediate results in a local memory.

9. The computing system of claim 1, wherein the connection table comprises:
an input array configured to store an indication of receipt of a valid input from a processing unit or memory unit in the network; and
an output array configured to store an indication that processing results are forwarded to an identified processing or memory unit in the network.

10. The computing system of claim 9, wherein each bit in the input array and in the output array points to one of the processing or memory units in the system.

11. The computing system of claim 1, wherein:
a first sub-set of the plurality of processing units implement only linear arithmetic functions; and
a second sub-set of the plurality of processing units implement only non-linear functions;
whereby, the first and second sub-sets of the plurality of processing units together implement the complete functions of a neuron.

12. The computing system of claim 1, wherein the neural network comprises a greater number of the first sub-set of processing units than the number of the second sub-set of processing units, whereby resource efficiency is enhanced.

13. The computing system of claim 1, wherein each of the plurality of processing units implements both linear arithmetic functions and non-linear functions of a neuron.

14. A method of mapping neural networks into a pool of processing units, the network having a plurality of layers including a first layer, the method, comprising:
a) receiving commands generated by machine learning workloads executing on a host processor;
b) when the first layer of the network is being processed, input data is fetched and assembled into packets;
c) if all layers have been processed, a determination is made whether more input data is available and, if so, the additional input data is fetched and assembled into packets;
d) if additional layers remain to be processed, weight data for neurons of the first additional layer are sequentially loaded and forwarded directly to processing units;
f) when weight data associated with all neurons in the currently processing layer have been sent to processing units, activation function used by all neurons in current layer is specified;
g) upon completion of the activation function in the current layer, the method loops back to step d) to process the neurons in the additional layers; and
h) when no layers remain to be processed, the method loops back to step c) to determine if more input data is available.
